(19) United States
(12) Patent Application Publication
(10) Pub. No.: US 2026/0171277 A1
(43) Pub. Date: Jun. 18, 2026

(54) METHOD FOR INTEGRATED TREATMENT OF RADIOACTIVE LIQUID WASTE GENERATED DURING DECOMMISSIONING OF NUCLEAR POWER PLANT

(71) Applicant: LCGen Co., Ltd., Gyeonggi-do (KR)

(72) Inventors: Jin Uk KANG, Gyeonggi-do (KR); Jeong Ki KANG, Gyeonggi-do (KR)

(73) Assignee: LCGen Co., Ltd., Gyeonggi-do (KR)

(21) Appl. No.: 19/329,505

(22) Filed: Sep. 15, 2025

(30) Foreign Application Priority Data
Oct. 16, 2024 (KR) 10-2024-0140957

(51) Int. Cl. G21F 9/06; G21F 9/30

(52) U.S. Cl. CPC G21F 9/06; G21F 9/30

(57) ABSTRACT

The present disclosure relates to a method for integrated treatment of radioactive liquid wastes generated during the decommissioning of a nuclear power plant, the method including: a radioactive liquid waste sorting and storing step (S100) of sorting the radioactive liquid waste generated into a low-concentration radioactive liquid waste, a high-concentration radioactive liquid waste, and an organic radioactive liquid waste; a primary treatment step (S200) of sorting and collecting foreign substances, oil, impurities, sediments, and solids contained in the radioactive liquid wastes; a secondary treatment step (S300) of removing the radioactive pollutants contained in the radioactive liquid wastes; and a tertiary treatment step (S400) of purifying the exhaust gas and discharge liquid discharged.

### CROSS REFERENCE TO RELATED APPLICATION OF THE DISCLOSURE

The present application claims the benefit of Korean Patent Application No. 10-2024-0140957 filed in the Korean Intellectual Property Office on Oct. 16, 2024, the entire contents of which are incorporated herein by reference.

### FIELD OF THE DISCLOSURE

### Background of the Disclosure

The present disclosure relates to a method for integrated treatment of radioactive liquid wastes generated during the decommissioning of a nuclear power plant, more specifically to a method for integrated treatment of radioactive liquid wastes generated during the decommissioning of a nuclear power plant that is capable of treating large amounts of radioactive liquid wastes generated during the decommissioning of the nuclear power plant according to the characteristics of the radioactive liquid wastes, thereby remarkably improving the treatment efficiency of the radioactive liquid wastes, reducing the treatment cost thereof, and greatly decreasing amounts of radioactive wastes as treatment results of the radioactive liquid wastes and amounts of secondary radioactive wastes generated during the treatment of the radioactive liquid wastes.

### Background of the Related Art

During the decommissioning of nuclear power plants, generally, decontamination is performed to remove radioactive materials from systems and equipment contaminated with the radioactive materials. The decontamination includes a physical method and a chemical method, and while the decontamination is being performed, large amounts of radioactive liquid wastes having various characteristics are generated.

Referring to FIG. 1, a conventional method for treating radioactive liquid wastes is performed by treating the radioactive liquid wastes having various characteristics through ion-exchange resin or by evaporating the radioactive liquid wastes through a waste liquid evaporator, and then solidifying the radioactive concentrate generated.

The conventional method for treating radioactive liquid wastes is disclosed in Korean Patent Application Laid-open No. 10-1999-0017159 (Dated on Mar. 15, 1999) and Korean Patent No. 10-1224725 (Issued on Jan. 15, 2013).

According to the conventional method for treating radioactive liquid wastes, the radioactive liquid wastes in the state of a solution that contains suspension, slurry, and chelate compounds are treated using the ion-exchange resin or evaporated using the evaporator, and after that, the radioactive concentrate generated is solidified.

In the conventional method for treating radioactive liquid wastes, however, if the ion-exchange resin is used, large amounts of filtered materials stick to the surface of the ion-exchange resin, so that an ion-exchange rate decreases within a short period of time to make the exchange period of the ion-exchange resin decrease, thereby greatly increasing an amount of radioactive waste resin as a secondary radioactive waste, and otherwise, if the evaporator is used, a long time for the concentration of large amounts of radioactive wastes is required, thereby remarkably reducing work efficiency, generating large amounts of radioactive concentrate solidified wastes, and consuming a high treatment cost for the treatment of the radioactive concentrate solidified wastes.

### SUMMARY OF THE DISCLOSURE

Accordingly, the present disclosure has been made in view of the above-mentioned problems occurring in the related art, and it is an object of the present disclosure to provide a method for integrated treatment of radioactive liquid wastes generated during the decommissioning of a nuclear power plant that is capable of sorting large amounts of radioactive liquid wastes generated during the decommissioning of the nuclear power plant into a low-concentration radioactive liquid waste in a state of an aqueous solution, a high-concentration radioactive liquid waste in states of aqueous suspension and slurry, and an organic radioactive liquid waste as an organic solvent according to their characteristics and treating the low-concentration radioactive liquid waste, the high-concentration radioactive liquid waste, and the organic radioactive liquid waste safely and reliably according to their designated treatment steps, thereby greatly reducing amounts of radioactive wastes as treatment results of the radioactive liquid wastes and amounts of secondary radioactive wastes generated during the treatment of the radioactive liquid wastes, remarkably improving the work efficiency for the treatment of the radioactive liquid wastes, and substantially reducing the treatment cost thereof.

To accomplish the above-mentioned objects, according to the present disclosure, there is provided a method for integrated treatment of radioactive liquid wastes generated during the decommissioning of a nuclear power plant, the method including: a radioactive liquid waste sorting and storing step of sorting the radioactive liquid waste generated during the decommissioning of the nuclear power plant into a low-concentration radioactive liquid waste, a high-concentration radioactive liquid waste, and an organic radioactive liquid waste to store the sorted wastes in respective storage tanks; a primary treatment step of sorting and collecting foreign substances, oil, impurities, sediments, and solids contained in the radioactive liquid wastes stored in the respective storage tanks in the radioactive liquid waste sorting and storing step and dissolving organic matter; a secondary treatment step of removing the radioactive pollutants contained in the radioactive liquid wastes passing through the primary treatment step, performing gas-liquid separation for a condensate from which the radioactive pollutants are removed, and thus generating exhaust gas and discharge liquid; and a tertiary treatment step of purifying the exhaust gas and discharge liquid that are discharged after the gas-liquid separation in the secondary treatment step and discharging the purified exhaust gas and discharge liquid to an exhaust and drainage system of a building.

### BRIEF DESCRIPTION OF THE DRAWINGS

The above and other objects, features and advantages of the present disclosure will be apparent from the following detailed description of the embodiments of the disclosure in conjunction with the accompanying drawings, in which:

FIG. 1 is a schematic view showing a conventional treatment method for radioactive liquid wastes generated from a nuclear power plant;

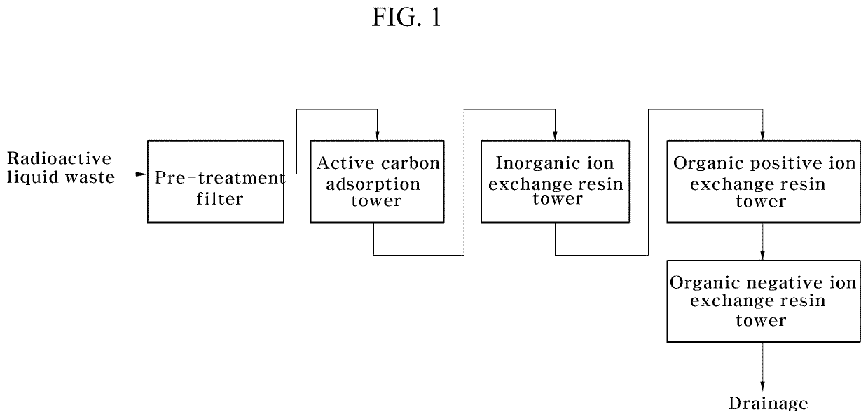

FIG. 2 is a flowchart showing a method for integrated treatment of radioactive liquid wastes generated during the decommissioning of a nuclear power plant according to the present disclosure;

FIG. 3 is a flowchart showing a primary treatment step of the method for integrated treatment of radioactive liquid wastes generated during the decommissioning of a nuclear power plant according to the present disclosure;

FIG. 4 is a flowchart showing a secondary treatment step of the method for integrated treatment of radioactive liquid wastes generated during the decommissioning of a nuclear power plant according to the present disclosure;

FIG. 5 is a flowchart showing a tertiary treatment of the method for integrated treatment of radioactive liquid wastes generated during the decommissioning of a nuclear power plant according to the present disclosure;

FIG. 6 is a flowchart showing an exhaust gas filtering step of the tertiary treatment of FIG. 5; and

FIG. 7 is a flowchart showing a condensate purification step of the tertiary treatment of FIG. 5.

### DETAILED DESCRIPTION OF THE PREFERRED EMBODIMENT

Objects, characteristics and advantages of the present disclosure will be more clearly understood from the detailed description as will be given below and the attached drawings. Before the present disclosure is given, it is to be understood that the disclosed embodiments are merely exemplary of the disclosure, which can be embodied in various forms. Those skilled in the art will envision many other possible variations within the scope of the present disclosure.

In explaining the example embodiments, detailed description on known elements or functions will be omitted if it is determined that such description will interfere with understanding of the embodiments. Further, the terms as will be discussed later are defined in accordance with the functions of the present disclosure, but may be varied under the intention or regulation of a user or operator. Therefore, they should be defined on the basis of the whole scope of the present disclosure.

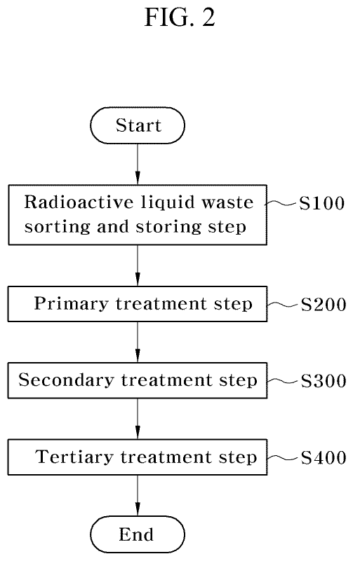

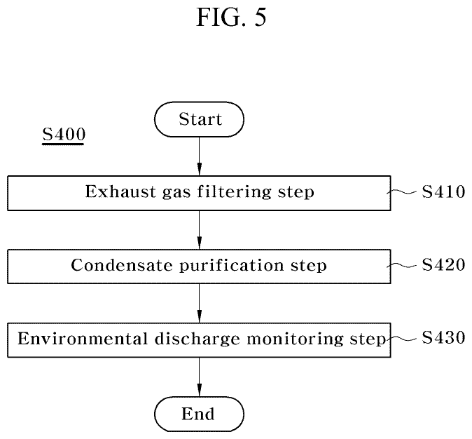

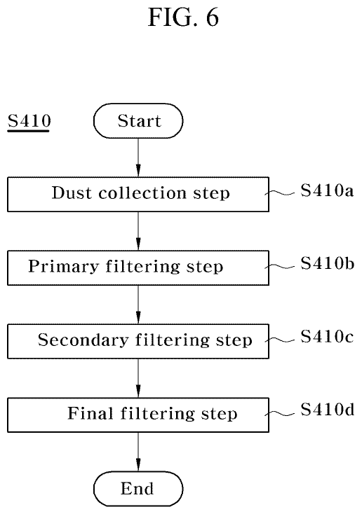

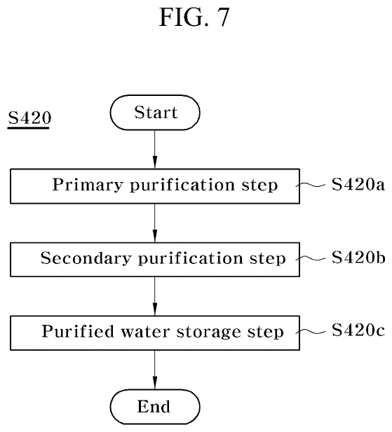

Hereinafter, a method for integrated treatment of radioactive liquid wastes generated during the decommissioning of a nuclear power plant according to an embodiment of the present disclosure will be explained in detail with reference to FIGS. 2 to 7.

Referring to FIGS. 2 to 7, the method for integrated treatment of radioactive liquid wastes generated during the decommissioning of a nuclear power plant according to the present disclosure includes a radioactive liquid waste sorting and storing step S100, a primary treatment step S200, a secondary treatment step S300, and a tertiary treatment step S400.

The radioactive liquid waste sorting and storing step S100 sorts the radioactive liquid wastes generated during the decommissioning of a nuclear power plant into a low-concentration radioactive liquid waste, a high-concentration radioactive liquid waste, and an organic radioactive liquid waste and then stores the sorted wastes in respective storage tanks.

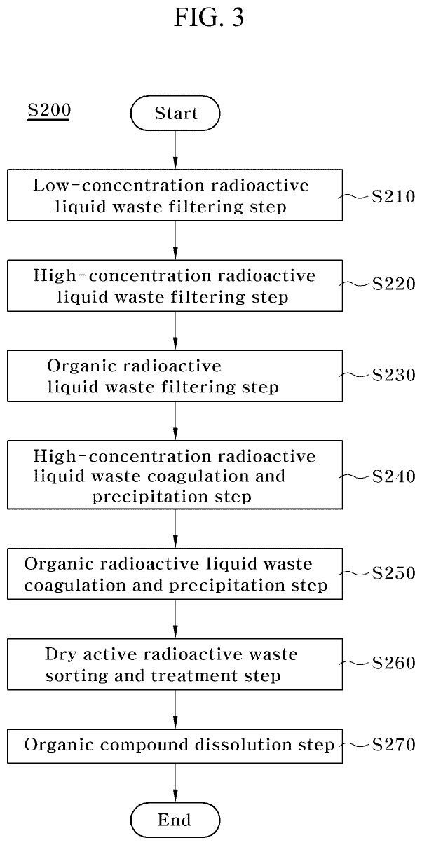

Referring to FIGS. 2 and 3, the primary treatment step S200 sorts and collects foreign substances, oil, impurities, sediments, and solids from the radioactive liquid wastes stored in the respective storage tanks in the radioactive liquid waste sorting and storing step S100 and also dissolves organic matter, and the primary treatment step S200 consists of a low-concentration radioactive liquid waste filtering step S210, a high-concentration radioactive liquid waste filtering step S220, an organic radioactive liquid waste filtering step S230, a high-concentration radioactive liquid waste coagulation and precipitation step S240, an organic radioactive liquid waste coagulation and precipitation step S250, a dry active radioactive waste sorting and treatment step S260, and an organic compound dissolution step S270.

The low-concentration radioactive liquid waste filtering step S210 sorts the foreign substances and oil contained in the low-concentration radioactive liquid waste through a foreign substance sorter and an oil sorter.

The high-concentration radioactive liquid waste filtering step S220 sorts the foreign substances and oil contained in the high-concentration radioactive liquid waste through a foreign substance sorter and an oil sorter.

The organic radioactive liquid waste filtering step S230 sorts the foreign substances and oil contained in the organic radioactive liquid waste through a foreign substance sorter and an oil sorter.

The high-concentration radioactive liquid waste coagulation and precipitation step S240 coagulates and precipitates the high-concentration radioactive liquid waste from which the foreign substances and oil are removed in the high-concentration radioactive liquid waste filtering step S220 and thus performs solid-liquid separation for the high-concentration radioactive liquid waste.

The organic radioactive liquid waste coagulation and precipitation step S250 coagulates and precipitates the organic radioactive liquid waste from which the foreign substances and oil are removed in the organic radioactive liquid waste filtering step S230 and thus performs solid-liquid separation for the organic radioactive liquid waste.

The dry active radioactive waste sorting and treating step S260 collects the foreign substances and oil sorted in the low-concentration radioactive liquid waste filtering step S210, the high-concentration radioactive liquid waste filtering step S220, and the organic radioactive liquid waste filtering step S230 and the radioactive solid wastes such as sediments sorted from the high-concentration and organic radioactive wastes in the high-concentration radioactive liquid waste coagulation and precipitation step S240 and the organic radioactive liquid waste coagulation and precipitation step S250, sorts the collected foreign substances, oil and radioactive solid wastes as dry active radioactive wastes, and treats the dry active radioactive wastes.

The organic compound dissolution step S270 dissolves, through underwater plasma, organic compounds contained in the organic radioactive liquid waste from which the radioactive solid wastes are removed in the organic radioactive liquid waste coagulation and precipitation step S250.

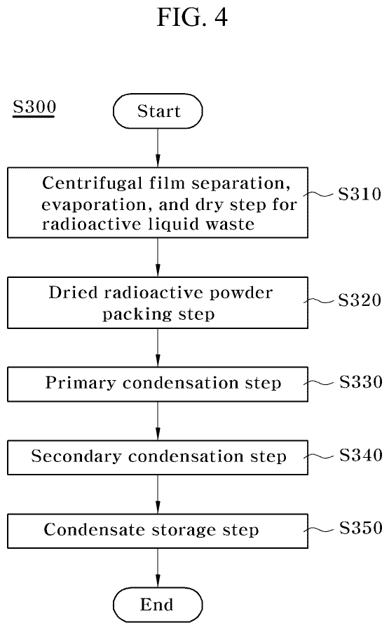

Referring to FIGS. 2 and 4, the secondary treatment step S300 removes radioactive pollutants contained in the radioactive liquid waste passing through the primary treatment step S200, performs gas-liquid separation for the condensate from which the radioactive pollutants are removed, and thus generates exhaust gas and discharge liquid, and the secondary treatment step S300 consists of a centrifugal film separation, evaporation, and dry step S310 for the radioactive liquid wastes, a dried radioactive powder packing step S320, a primary condensation step S330, a secondary condensation step S340, and a condensate storage step S350.

The centrifugal film separation, evaporation, and dry step S310 for the radioactive liquid wastes performs centrifugal film separation for the low-concentration inorganic radioactive liquid waste from which the foreign substances and oil are removed in the low-concentration radioactive liquid waste filtering step S210, the high-concentration inorganic radioactive liquid waste from which the radioactive solid wastes such as sediments is removed in the high-concentration radioactive liquid waste filtering step S220, and the organic radioactive liquid waste in which the organic compounds are dissolved in the organic compound dissolution step S270, through thin film cyclone dryer equipment, to separate radioactive microparticles from the wastes, then evaporates and dries the separated radioactive microparticles, and finally produces dried radioactive powder.

The dried radioactive powder packing step S320 packs the dried radioactive powder produced through the centrifugal film separation, evaporation, and dry step S310 for the radioactive liquid wastes, with a high integrity container.

The primary condensation step S330 performs the condensation of steam in the exhaust gas evaporated in the centrifugal film separation, evaporation, and dry step S310 for the radioactive liquid wastes, through a condenser.

The secondary condensation step S340 performs the condensation of the steam contained in the exhaust gas passing through the primary condensation step S330 through a gas-liquid two-phase flow centrifugal separator.

The condensate storage step S350 collects the condensate produced in the primary condensation step S330 and the secondary condensation step S340 and stores the condensate in a storage tank.

Referring to FIGS. 2 and 5 to 7, the tertiary treatment step S400 purifies the exhaust gas and discharge liquid that are discharged after the gas-liquid separation in the secondary treatment step S300 and discharges the purified exhaust gas and discharge liquid to an exhaust and drainage system of a building, and the tertiary treatment step S400 consists of an exhaust gas filtering step S410, a condensate purification step S420, and an environmental discharge monitoring step S430.

The exhaust gas filtering step S410 filters the exhaust gas from which the steam is removed after passing through the secondary condensation step S340 of the secondary treatment step S300 and then discharges the exhaust gas, and the exhaust gas filtering step S410 consists of a dust collection step S410a, a primary filtering step S410b, a secondary filtering step S410c, and a final filtering step S410d.

The dust collection step S410a removes dust contained in the exhaust gas from which the steam is removed after passing through the secondary condensation step S340 of the secondary treatment step S300 through dust collection means, and desirably, the dust collection means is cyclone equipment combining a cyclone with a bag filter or a dust scrubber.

The primary filtering step S410b removes dust contained in the exhaust gas from which dust is removed after passing through the dust collection step S410a through a preliminary filter.

The secondary filtering step S410c removes microparticles contained in the exhaust gas passing through the primary filtering step S410b through a high-performance filter, and desirably, the high-performance filter is a High-Efficiency Particulate Air (HEPA) filter.

The final filtering step S410d removes iodine (I) contained in the exhaust gas passing through the secondary filtering step S410c through a charcoal filter.

The condensate purification step S420 purifies and discharges the condensate stored in the condensate tank in the condensate storage step S350 of the secondary treatment step S300, and the condensate purification step S420 consists of a primary purification step S420a, a secondary purification step S420b, and a purified water storage step S420c.

The primary purification step S420a allows the condensate to pass through a film separator to produce purified water, and desirably, the film separator is microfiltration (MF) and reverse osmosis (RO) equipment.

The secondary purification step S420b removes ionic compounds contained in the purified water produced in the primary purification step S420a through an ion-exchange resin.

The purified water storage step S420c stores the purified water passing through the secondary purification step S420b in a purified water storage tank and discharges the purified water if necessary.

The environmental discharge monitoring step S430 monitors the atmosphere to which the exhaust gas is emitted after passing through the exhaust gas filtering step S410 and a quality of the water to which the condensate is discharged after passing through the condensate purification step S420.

As described above, the method for integrated treatment of radioactive liquid wastes generated during the decommissioning of a nuclear power plant according to the present disclosure sorts the radioactive liquid wastes having various characteristics that are generated during the decommissioning of the nuclear power plant into the low-concentration, high-concentration, and organic radioactive liquid wastes, performs the primary treatment step according to the characteristics of the respective radioactive liquid wastes, the secondary treatment step in which the radioactive pollutants contained in the radioactive liquid wastes passing through the primary treatment step are removed, and the tertiary treatment step in which the exhaust gas and discharge liquid produced through the second treatment step are purified sequentially, and finally discharges the purified exhaust gas and water, thereby remarkably improving the treatment efficiency of the radioactive liquid wastes, reducing the treatment cost thereof, and greatly decreasing amounts of radioactive waste resins and secondary radioactive wastes generated.

Although specific embodiments have been illustrated and described herein, it will be appreciated by those of ordinary skill in the art that any arrangement, which is calculated to achieve the same purpose, may be substituted for the specific embodiment shown.

It is to be understood that the disclosed embodiments are merely exemplary of the disclosure, which can be embodied in various forms. This application is intended to cover any adaptations or variations of the present disclosure. Therefore, it is manifestly intended that this disclosure be limited only by the claims and the equivalents thereof.

What is claimed is:

1. A method for integrated treatment of radioactive liquid wastes generated during the decommissioning of a nuclear power plant, the method comprising:
a radioactive liquid waste sorting and storing step (S100) of sorting the radioactive liquid waste generated during the decommissioning of the nuclear power plant into a low-concentration radioactive liquid waste, a high-concentration radioactive liquid waste, and an organic radioactive liquid waste to store the sorted wastes in respective storage tanks;
a primary treatment step (S200) of sorting and collecting foreign substances, oil, impurities, sediments, and solids contained in the radioactive liquid wastes stored in the respective storage tanks in the radioactive liquid waste sorting and storing step (S100) and dissolving organic matter, the primary treatment step (S200) consisting of a low-concentration radioactive liquid waste filtering step (S210) of sorting the foreign substances and oil contained in the low-concentration radioactive liquid waste through a foreign substance sorter and an oil sorter, a high-concentration radioactive liquid waste filtering step (S220) of sorting the foreign substances and oil contained in the high-concentration radioactive liquid waste through a foreign substance sorter and an oil sorter, an organic radioactive liquid waste filtering step (S230) of sorting the foreign substances and oil contained in the organic radioactive liquid waste through a foreign substance sorter and an oil sorter, a high-concentration radioactive liquid waste coagulation and precipitation step (S240) of coagulating and precipitating the high-concentration radioactive liquid waste from which the foreign substances and oil are removed in the high-concentration radioactive liquid waste filtering step (S220) and thus performing solid-liquid separation for the high-concentration radioactive liquid waste, an organic radioactive liquid waste coagulation and precipitation step (S250) of coagulating and precipitating the organic radioactive liquid waste from which the foreign substances and oil are removed in the organic radioactive liquid waste filtering step (S230) and thus performing solid-liquid separation for the organic radioactive liquid waste, a dry active radioactive waste sorting and treatment step (S260) of collecting the foreign substances and oil sorted in the low-concentration radioactive liquid waste filtering step (S210), the high-concentration radioactive liquid waste filtering step (S220), and the organic radioactive liquid waste filtering step (S230) and the radioactive solid wastes such as sediments sorted from the high-concentration and organic radioactive wastes in the high-concentration radioactive liquid waste coagulation and precipitation step (S240) and the organic radioactive liquid waste coagulation and precipitation step (S250), sorting the collected foreign substances, oil and radioactive solid wastes as dry active radioactive wastes, and treating the dry active radioactive wastes, and an organic compound dissolution step (S270) of dissolving, through underwater plasma, the organic compounds contained in the organic radioactive liquid waste from which the radioactive solid wastes are removed in the organic radioactive liquid waste coagulation and precipitation step (S250);
a secondary treatment step (S300) of removing the radioactive pollutants contained in the radioactive liquid wastes passing through the primary treatment step (S200), performing gas-liquid separation for the condensate from which the radioactive pollutants are removed, and thus generating exhaust gas and discharge liquid; and
a tertiary treatment step (S400) of purifying the exhaust gas and discharge liquid that are discharged after the gas-liquid separation in the secondary treatment step (S300) and discharging the purified exhaust gas and discharge liquid to an exhaust and drainage system of a building, the tertiary treatment step (S400) consisting of an exhaust gas filtering step (S410) of filtering the exhaust gas from which the steam is removed after passing through the secondary treatment step (S300) and then discharging the exhaust gas, a condensate purification step (S420) of purifying and discharging the condensate stored in the condensate tank in the secondary treatment step (S300), and an environmental discharge monitoring step (S430) of monitoring atmosphere to which the exhaust gas is emitted after passing through the exhaust gas filtering step (S410) and a quality of the water to which the condensate is discharged after passing through the condensate purification step (S420),
wherein the secondary treatment step (S300) comprises:
a centrifugal film separation, evaporation, and dry step (S310) for the radioactive liquid wastes of performing centrifugal film separation for the low-concentration inorganic radioactive liquid waste from which the foreign substances and oil are removed in the low-concentration radioactive liquid waste filtering step (S210), the high-concentration inorganic radioactive liquid waste from which the radioactive solid wastes such as sediments is removed in the high-concentration radioactive liquid waste filtering step (S220), and the organic radioactive liquid waste in which the organic compounds are dissolved in the organic compound dissolution step (S270), through thin film cyclone dryer equipment, to separate radioactive microparticles from the wastes, then evaporating and drying the separated radioactive microparticles, and finally producing dried radioactive powder;
a dried radioactive powder packing step (S320) of packing the dried radioactive powder produced in the centrifugal film separation, evaporation, and dry step (S310) for the radioactive liquid wastes, with a high integrity container;
a primary condensation step (S330) of performing the condensation of the steam in the exhaust gas evaporated in the centrifugal film separation, evaporation, and dry step (S310) for the radioactive liquid wastes, through a condenser;
a secondary condensation step (S340) of performing the condensation of the steam contained in the exhaust gas passing through the primary condensation step (S330), through a gas-liquid two-phase flow centrifugal separator; and
a condensate storage step (S350) of collecting the condensate produced in the primary condensation step (S330) and the secondary condensation step (S340) and storing the condensate in a storage tank.

2. The method according to claim 1, wherein the exhaust gas filtering step (S410) comprises:
a dust collection step (S410a) of removing dust contained in the exhaust gas from which the steam is removed after passing through the secondary condensation step (S340) of the secondary treatment step (S300) through dust collection means;
a primary filtering step (S410b) of removing dust contained in the exhaust gas from which dust is removed after passing through the dust collection step (S410a) through a preliminary filter;
a secondary filtering step (S410c) of removing microparticles contained in the exhaust gas passing through the primary filtering step (S410b) through a high-performance filter; and
a final filtering step (S410d) of removing iodine (I) contained in the exhaust gas passing through the secondary filtering step (S410c) through a charcoal filter.

3. The method according to claim 1, wherein the condensate purification step (S420) comprises:
a primary purification step (S420a) of allowing the condensate to pass through a film separator to produce purified water;
a secondary purification step (S420b) of removing ionic compounds contained in the purified water produced in the primary purification step (S420a) through an ion-exchange resin; and
a purified water storage step (S420c) of storing the purified water passing through the secondary purification step (S420b) in a purified water storage tank and discharging the purified water if necessary.

4. The method according to claim 2, wherein the dust collection means in the dust collection step (S410a) is cyclone equipment combining a cyclone and a bag filter.

5. The method according to claim 2, wherein the dust collection means in the dust collection step (S410a) is a dust scrubber.

6. The method according to claim 2, wherein the high-performance filter in the secondary filtering step (S410c) is a High-Efficiency Particulate Air (HEPA) filter.

7. The method according to claim 3, wherein the film separator in the primary purification step (S420a) is microfiltration (MF) and reverse osmosis (RO) equipment.
